(19) United States
(12) Patent Application Publication
(10) Pub. No.: US 2021/0002058 A1
(43) Pub. Date: Jan. 7, 2021

(54) SYSTEM FOR PACKAGING TWO COMPONENTS

(71) Applicant: SIKA TECHNOLOGY AG, Baar (CH)

(72) Inventors: Dana MAIWALD, Zürich (CH); Nicole JAGIELSKI, Zürich (CH); Torsten FUNK, Stallikon (CH)

(73) Assignee: SIKA TECHNOLOGY AG, Baar (CH)

(21) Appl. No.: 16/982,740

(22) PCT Filed: Apr. 3, 2019
(86) PCT No.: PCT/EP2019/058436

§ 371 Date: Sep. 21, 2020

(30) Foreign Application Priority Data
Apr. 16, 2018 (EP) 18167605.7

(51) Int. Cl. B65D 81/32; B65D 51/28; B65B 29/10; B01F 15/00; B01F 7/26; B01F 15/02

(52) U.S. Cl. CPC B65D 81/3222; B65D 51/28; B65B 29/10; B01F 15/00805; B01F 2215/006; B01F 7/26; B01F 15/0224; B01F 2215/0039; B01F 15/00006

(57) ABSTRACT

A system for packaging two components which includes a first container, which is intended for accommodating a first component and has a lid. The system further includes a second container for accommodating a second component, wherein the second container is arranged in a volume of the first container. The system further includes a mixing head, which seals the second container in relation to the first container.

The present invention relates to a system for packaging two components. In particular, the invention relates to a system for two components which are mixed by a user prior to use.

For various applications, products comprise two components which must be mixed together by the user prior to use. For storage and transport, the two components must however be kept separate from one another because the product would otherwise react in an undesirable manner prior to use. For instance, two-component coatings or adhesives which must be mixed together directly prior to use are often packaged in this way.

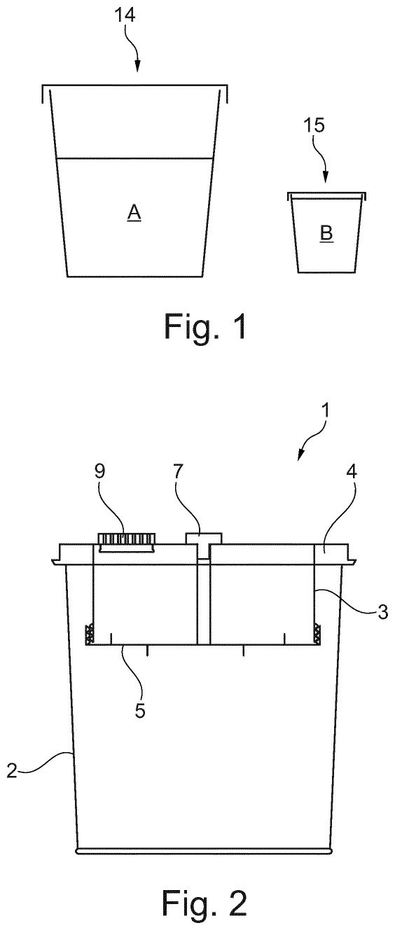

In FIG. 1, a previously known product for two liquid components is represented. The product here comprises a first bucket 14, in which the component A is kept. In addition, the product comprises a second bucket 15, in which a second component B is kept. Prior to use, the lids of the buckets 14, 15 are now opened, and the liquid component B is emptied into the first bucket 14 into the liquid component A. After this, the liquid components A and B are typically mixed together using a mixer, and the two-component product which is in this way produced is used accordingly.

A drawback with known products of this kind is that, on the one hand, empty space exists in the first bucket 14, which space gives rise to unnecessarily high storage and transport costs. On the other hand, it is disadvantageous, moreover, that the logistical effort is large, because it must constantly be ensured that, for an application, respectively a precise number of buckets containing the first component and a precise number of buckets containing the second component are present.

Furthermore, there is the danger that a user, in the course of the transferal and mixing, comes into undesirable contact with the products themselves or with vapors from the products.

It is therefore an object of the present invention to provide an improved system for packaging two components, which system, on the one hand, enables lower storage and transport costs and, on the other hand, reduces the logistical effort for the formulation of the product. Moreover, the improved system is intended to be as simple, safe and efficient as possible in its use.

This object is achieved by a system for packaging two components, the system comprising: a first container for receiving a first component and having a lid; a second container for receiving a second component, wherein the second container is arranged in a volume of the first container when the first container is closed off with the lid; and a mixing head, which seals off the second container from the first container.

The here proposed solution offers the advantage that, by integrating the second component in the volume of the first container, a substantial space saving can be achieved, which in turn leads to lower storage and transport costs. The system which is here proposed enables both components to be stored and transported separately, and yet enables both components to be kept in a container in which the components, moreover, are mixed together prior to use.

A further advantage of the system which is here proposed lies in the fact that the logistical effort can be heavily reduced: since both components are always packaged one with the other, it is automatically ensured that the number of units of the first component and the number of units of the second component is constantly in the correct ratio. Moreover, operating errors, such as, for instance, the mixing of components which do not belong together, can thereby be precluded.

The provision of a mixing head for sealing off the second containers from the first container further offers the advantage that an element for mixing the two components is already integrated in the system. This in turn allows the components to be mixed together without the lid of the first container being opened. Undesirable contacts with the components, or vapors of the components, and a user can thus be avoided.

A central idea of the present invention consists in, by integrating the second container and the mixing head in the first container, on the one hand improving the logistics and storage of the hitherto known products and, on the other hand, simplifying an application, in particular an application in the mixing of the components. and making this safer.

The first container can be configured, for instance, as a bucket or as a cylindrical container or as a conical container or as a cuboid container or as an irregularly shaped container.

In an exemplary embodiment, the system is designed for the packaging of two liquid components.

In an exemplary alternative embodiment, the system is configured for the packaging of a liquid and a pasty, pellet-like, granular or powdery component. The system can here either be configured such that the liquid component is packaged in the first container, or else is packaged such that the liquid component is packaged in the second container.

The components can be, for instance, a two-component adhesive or a two-component sealant or a two-component primer.

Concrete examples of the components to be packaged by the system are:

a two-component adhesive, in particular on an epoxy resin base, such as, for instance, the product available under the trade name Sikadur® 31;

a two-component sealant, in particular on a polyurethane base, such as, for instance, the product available under the trade name Sikafloor® 304;

A two-component primer, in particular on an epoxy resin base, such as, for instance, the product available under the trade name Sikafloor® 156.

A ratio of a volume of the second component to the first component can lie, for instance, between 1:100 and 1:1, or between 1:50 and 1:2, or between 1:20 and 1:3.

A ratio of the volumes of the second container to a volume of the first container can lie, for instance, between 1:100 and 1:1, or between 1:50 and 1:2, or between 1:20 and 1:3.

In an exemplary embodiment, a volume of the first container amounts to between 0.5 dm³ and 50 dm³, preferredly between 1 dm³ and 30 dm³, preferredly between 1.5 dm³ and 25 dm³, particularly preferredly between 2 dm³ and 20 dm³.

The provision of a first container having such a volume offers the advantage that the advantages cited in the introduction are able to be utilized, in particular, for two-component building materials (such as, for instance, adhesives, primers and sealants), which are typically used in packages having the above-stated volumes.

The lid is in particular designed such that the first container, when the lid is closed, is closed off in a fluid-tight and/or gas-tight and/or vapor-tight manner. In order to achieve this, the lid can be equipped, for instance, with a screw thread, or the lid can close off the first container in the manner of a tin can closure.

In an exemplary embodiment, a first sealing element is arranged on the second container and a second sealing element is arranged on the mixing head.

The two sealing elements are here in particular designed such that they cooperate in order to seal off the second container from the first container.

These sealing elements can here be different in design.

In a first exemplary refinement, the first sealing element and the second sealing element respectively comprise a screw thread, so that the mixing head is screwable to the second container in order to seal off the second container in a fluid-tight and/or gas-tight and/or vapor-tight manner from the first container.

In a preferred embodiment, the mixing head here substantially forms a base of the second container.

Such an arrangement with screw threads offers the advantage that, on the one hand, a secure sealing can be achieved, and that, on the other hand, the mixing head can be easily manipulated from outside such that it is released from the second container, in particular by a rotation of the mixing head. As a result, the second component can be emptied into the first component from outside without the lid of the first container being opened.

In an alternative refinement, the first sealing element and/or the second sealing element is/are configured as an elastic element. The elastic element is here configured, in particular, as a sealing lip.

In an exemplary embodiment, the mixing head can here be arranged on a base of the second container, which base has at least one opening, in such a way that the sealing elements seal off the second container from the first container.

Such an arrangement comprising elastic elements, in particular comprising sealing lips, offers the advantage that the second container can be sealed off by simple pressing.

Moreover, the second container can here too be opened from outside, that is to say without the lid of the first container being opened, so that the second component is emptied into the first component.

In an exemplary embodiment, the system comprises an extension element, in particular a rod-shaped extension element, which can be operatively connected to the mixing head in order to vertically displace the mixing head.

Such an extension element offers the advantage that not only can the mixing head thereby be slightly displaced in order to open the second container to the first container, but that that the mixing head can be vertically moved sufficiently far that the components can be efficiently mixed together. This can once again happen without the lid of the first container being opened.

In an exemplary embodiment, the extension element can be operatively connected to the mixing head by a screwed joint.

In an exemplary embodiment, the extension element is of rod-shaped configuration and is designed to be pushed through the lid of the first container.

The extension element can here be configured, for instance, such that it can be connected at its free end to a drilling machine or similar, in order to set the mixing head in a rotary motion.

In an exemplary embodiment, the mixing head comprises a shaft and a disk.

In an exemplary embodiment, the mixing head comprises agitator pins. In an exemplary refinement, the agitator pins are configured such that they project away from the mixing head. The agitator pins can here, for instance, project vertically, horizontally or obliquely away from the mixing head.

The fitting of such agitator pins offers the advantage that a mixing can thereby be performed faster and/or more efficiently.

In an exemplary embodiment, the mixing head comprises spacer elements, which project horizontally away from the mixing head. In particular, the spacer elements are here arranged on an outer rim of a disk of the mixing head.

These spacer elements have the advantage that the mixing head, in the mixing process, can be better centered, in that they butt against the side wall of the first container. Moreover, these spacer elements can also be used as scrapers when the mixing head, after the mixing, is extracted from the first container.

In an exemplary embodiment, the second container is arranged on the lid of the first container.

In an alternative embodiment, the second container comprises a base having at least one opening and is bounded, moreover, by walls and lid of the first container.

In an exemplary embodiment, the lid has a filling apparatus.

In an exemplary embodiment, the first container and/or the second container and/or the mixing head is formed at least partially of plastic or of tin plate or of steel.

Depending on the products used or depending on the components used, a different material for the containers or for the mixing head can be advantageous.

Furthermore, a product which comprises: a previously described system; and a first component arranged in the first container; and a second component arranged in the second container, is proposed.

Moreover, a method for achieving the object stated in the introduction is additionally proposed. The method for storing and using two jointly packaged components here comprises the steps: provision of a first container and a second container, wherein the second container is arranged in a volume of the first container; provision of a mixing head for sealing off the second container; filling of the first container with a quantity of the first component; filling of the second container with a quantity of the second component; storage of the two components in the two containers; displacement of the mixing head in the vertical direction in order thereby to open the second container to the first container and to join together the components, while the first container is closed off by the lid; mixing of the components, wherein the mixing head is rotated about a rotational axis, and/or wherein the mixing head is moved in the vertical direction, while the first container is closed off by the lid; and use of the mixture by opening of the first container and removal of the mixture from the first container.

In an exemplary refinement, the above-described method is implemented with a previously described system.

Details and advantages of the invention are described in greater detail below on the basis of illustrative embodiments and with reference to schematic drawings, wherein:

FIG. 1 shows a schematic representation of a product having two components according to the prior art;

FIG. 2 shows a schematic representation of an exemplary system for packaging two components;

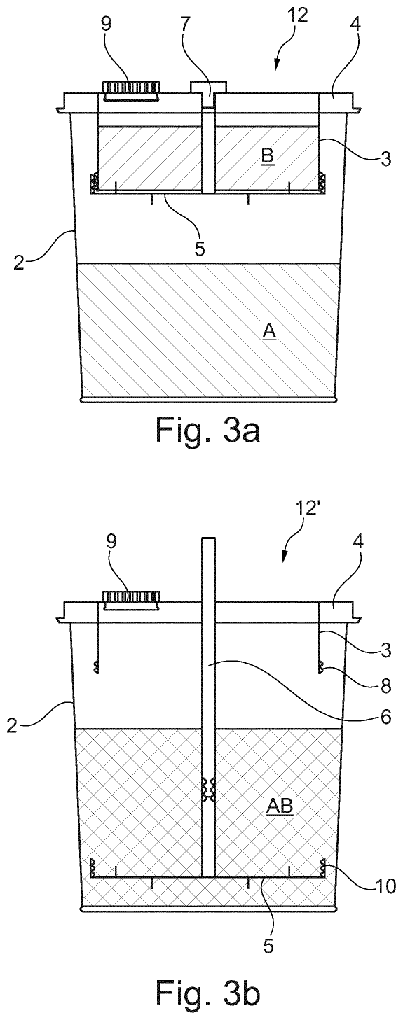

FIGS. 3a and 3b show a schematic representation of an exemplary product having two components;

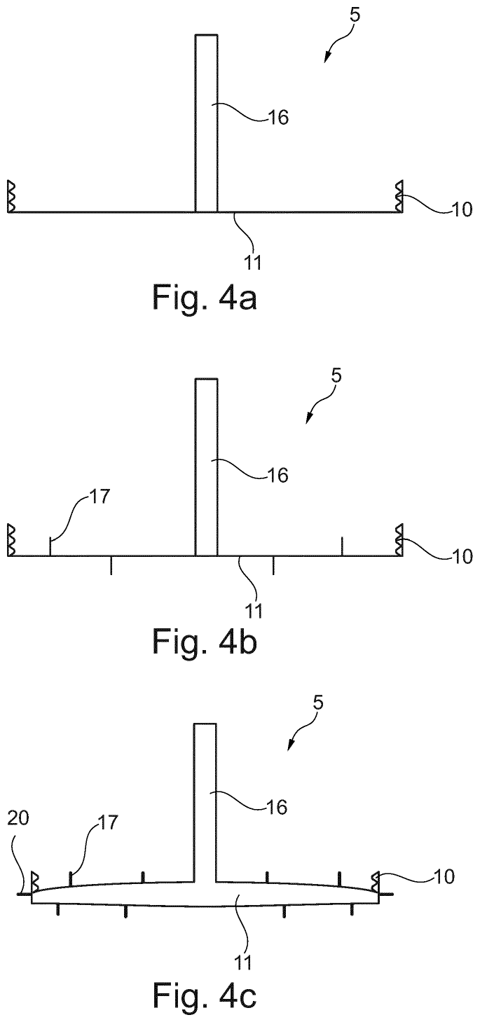

FIGS. 4a to 4c show a schematic representation of an exemplary mixing head;

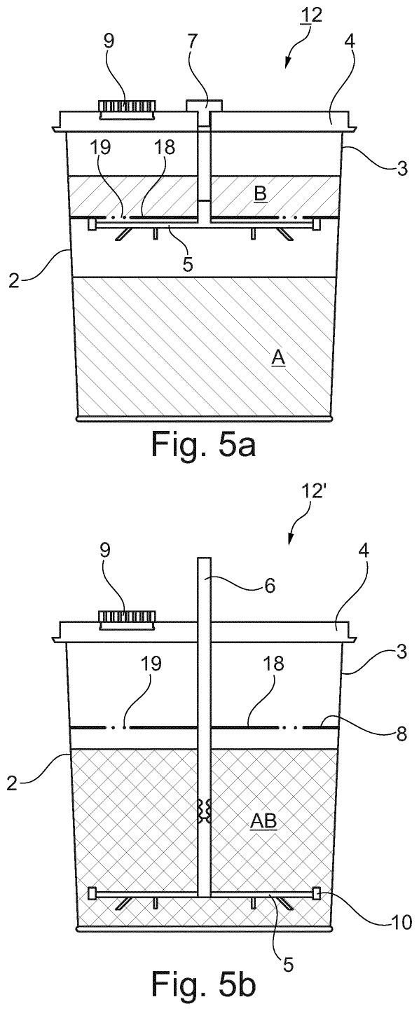

FIGS. 5a and 5b show a schematic representation of an exemplary product having two components;

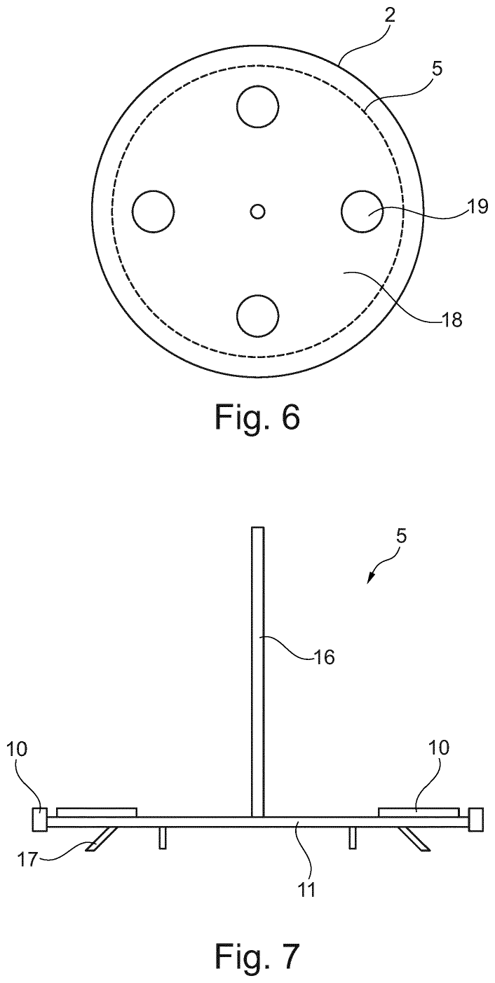

FIG. 6 shows a schematic representation of an exemplary separating device between first container and second container; and

FIG. 7 shows a schematic representation of an exemplary mixing head.

In FIG. 2, a system 1 for packaging two components is represented by way of example and schematically. The system 1 here comprises a first container 2, having a lid 4, and a therein arranged second container 3. The second container 3 is here sealed off from the first container 2 by a mixing head 5. In this illustrative embodiment, the second container 3 is arranged on the lid 4 of the first container 2.

In this illustrative embodiment, the lid 4 comprises a filling apparatus 9 and a closure element 7. The closure element 7 can be arranged on the mixing head 5, for instance, by means of a screw thread. As a result, the closure element 7 can be easily removed from the mixing head 5, and, in place of the closure element 7, a drilling machine, for instance, can be operatively connected to the mixing head 5 in order, for instance, to open or close the second container 3 or to rotatingly drive the mixing head 5.

In FIGS. 3a and 3b, the system 1 from FIG. 2 is now in a usage state, that is to say is represented, by way of example, with the first component A and with the second component B or with the mixture of these two components A, B. In FIG. 3a, the product 12 is here represented in a storage state, and in FIG. 3b the product 12′ is represented in a usage state.

In the storage state according to FIG. 3a, the first component A and the second component B are separated from one another. The mixing head 5 here seals off the second container 3 from the first container 2. In order to mix together the components A, B, the closure element 7 is now removed, an extension element 6 is operatively connected to the mixing head 5, and the mixing head 5 is vertically displaced, so that the second component B empties into the first container 2 into the component A. In order to be able to better mix together the components A, B, the mixing head 5 can afterward be rotated about a rotational axis, or the mixing head 5 can be moved vertically up and down. During the joining together of the components A, B and during the further intermixing of the components A, B, the lid 4 of the first container 2 remains constantly closed. It can thereby be prevented that undesirable contact is made between the components A, B, or vapors of these components A, B, and a user.

In FIGS. 4a to 4c are represented various illustrative embodiments of a mixing head 5 as can be used, for instance, in a system 1 according to FIG. 2, or in a product 12, 12′ according to FIGS. 3a and 3b.

According to the represented illustrative embodiments, the mixing head 5 respectively comprises a shaft 16 and a disk 11. On this disk 11 are here arranged agitator pins 17. Moreover, on this disk 11 is arranged the second sealing element 10, which can cooperate with a first sealing element 8 arranged on the second container 3.

As can be seen from FIGS. 4a to 4c, in particular the disk 11 and the agitator pins 17 can be configured in different variants, respectively tailored to the employed components A, B.

The exemplary embodiment of the mixing head 5 in FIG. 4c comprises, moreover, spacer elements 20, which project horizontally away from the disk 11 of the mixing head 5. These spacer elements 20 can serve, for instance, to center the mixing head 5 in the mixing process, in that they butt against the side wall of the first container 2. Moreover, these spacer elements 20 can also be used as scrapers when the mixing head 5, after the mixing, is extracted from the first container 2.

In FIGS. 5a to 7, a second illustrative embodiment of a product 12 and its components A, B is represented by way of example. In FIG. 5a, the product 12 is here represented in a storage state, in FIG. 5b the same product 12′ is represented in a usage state, in FIG. 6 a separating device for separating the first container 2 and the second container 3 is represented in top view, and in FIG. 7 an exemplary mixing head 5 is represented.

As can be seen from these figures, in this illustrative embodiment the second container 3 is separated from the first container 2 by a base 18. The walls and the lid 4 of the first container 2 here also bound the second container 3. In the base 18 is arranged at least one opening 19. In a storage state of the product 12 (FIG. 5a), this opening 19 in the base 18 is now sealed off by the mixing head 5. Once again, both the mixing head 5 has a sealing element and the second container 3 has a sealing element. In this illustrative embodiment, the second sealing element 10 on the mixing head 5 is configured as an elastic element, in particular as a sealing lip, and the first sealing element 8 on the second container 3 is designed as a portion of the base 18.

For the mixing of the first component A with the second component B, the closure element 7 is removed once again and the mixing head 5 is vertically displaced to an extent that the sealing elements 8, 12 no longer seal off the second container 3, so that the second component B empties into the first container 2 into the first component A.

For better mixing of the components A, B, the mixing head 5 can now be further vertically displaced, in particular with the aid of an extension element 6. The mixing head 5 can here now be moved vertically back and forth, or else the mixing head 5 can be rotated in a rotary motion about its rotational axis in order to further mix together the components A, B.

In FIG. 6, the base 18 with the openings 19 provided therein is represented by way of example in top view. The base 18 is here laterally bounded by the wall of the first container 2. In this representation, the mixing head 5 is arranged behind the base 18 and closes off the openings 19, so that the second container 3 is sealed off from the first container 2.

In FIG. 7 is represented an exemplary mixing head 5 as can be used in a product 12, 12′ according to FIGS. 5a and 5b. The mixing head 5 once again has a shaft 16 and a disk 11. On the disk 11 are here arranged both the second sealing element 10 and the agitator pins 17.

The second sealing element 10 is here represented, on the one hand, as a sheet-like elastic element, which acts directly on the openings 19 in the base 18 and, on the other hand, as a sealing lip on the rim of the disk 11, in order to additionally seal off the second container 3.

### REFERENCE SYMBOL LIST

1 system
2 first container
3 second container
4 lid
5 mixing head
6 extension element
7 closure element
8 first sealing element
9 filling apparatus
10 second sealing element
11 disk
12 product in the storage state
12′ product in the usage state
14 first bucket
15 second bucket
16 shaft
17 agitator pin
18 base
19 opening
20 spacer element
A first component
B second component

1. A system for packaging two components, the system comprising:
a first container for receiving a first component and having a lid;
a second container for receiving a second component, wherein the second container is arranged in a volume of the first container when the container is closed off with the lid; and
a mixing head, which seals off the second container from the first container.

2. The system as claimed in claim 1, wherein a first sealing element is arranged on the second container, and wherein a second sealing element is arranged on the mixing head.

3. The system as claimed in claim 2, wherein the first sealing element and the second sealing element respectively comprise a screw thread, so that the mixing head is screwable to the second container in order to close off the second container in a fluid-tight and/or gas-tight and/or vapor-tight manner.

4. The system as claimed in claim 3, wherein the mixing head substantially forms a base of the second container.

5. The system as claimed in claim 2, wherein the first sealing element and/or the second sealing element is/are configured as an elastic element.

6. The system as claimed in claim 5, wherein the elastic element is configured as a sealing lip.

7. The system as claimed in claim 5, wherein the mixing head can be arranged on a base of the second container, which base has at least one opening, in such a way that the sealing elements seal off the second container from the first container.

8. The system as claimed in claim 1, wherein the system comprises an extension element, which can be operatively connected to the mixing head in order to vertically displace the mixing head.

9. The system as claimed in claim 8, wherein the extension element is configured as a rod-shaped element, and/or wherein the extension element can be operatively connected to the mixing head by a screwed joint.

10. The system as claimed in claim 1, wherein the mixing head comprises a shaft and a disk, and/or wherein the mixing head comprises agitator pins, which project away from the mixing head.

11. The system as claimed in claim 1, wherein the second container is arranged on the lid of the first container.

12. The system as claimed in claim 1, wherein the second container comprises a base having at least one opening and is bounded, moreover, by walls and lid of the first container.

13. A product comprising:
a system as claimed in claim 1;
a first component arranged in the first container; and
a second component arranged in the second container.

14. A method for storing and using two jointly packaged components, the method comprising the steps:
provision of a first container and a second container, wherein the second container is arranged in a volume of the first container;
provision of a mixing head for sealing off the second container from the first container;
filling of the first container with a quantity of the first component;
filling of the second container with a quantity of the second component;
storage of the two components in the two containers;
displacement of the mixing head in the vertical direction in order thereby to open the second container to the first container and to join together the components, while the first container is closed off by the lid;
mixing of the components, wherein the mixing head is rotated about a rotational axis and/or is moved in the vertical direction, while the first container is closed off by the lid; and
use of the mixture by opening of the first container and removal of the mixture from the first container.

15. The method as claimed in claim 14, wherein the method is implemented with the system for packaging two components, the system comprising:
the first container for receiving a first component and having the lid;
the second container for receiving the second component, wherein the second container is arranged in the volume of the first container when the container is closed off with the lid; and
the mixing head, which seals off the second container from the first container.
